(19) United States
(12) Patent Application Publication
(10) Pub. No.: US 2008/0042441 A1
(43) Pub. Date: Feb. 21, 2008

(54) METHOD FOR THE OPERATION OF A WIND TURBINE GENERATOR SYSTEM

(75) Inventor: Wolfgang Kabatzke, Geesthacht (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Nordex Energy GmbH, Norderstedt (DE)

(21) Appl. No.: 11/749,835

(22) Filed: May 17, 2007

(30) Foreign Application Priority Data
Aug. 19, 2006 (DE) 10 2006 039 029.6
Aug. 31, 2006 (DE) 10 2006 040 970.1

(51) Int. Cl. F03D 7/00

(52) U.S. Cl. 290/44; 415/1; 415/30

(57) ABSTRACT

A method for the operation of a wind turbine generator plant with a rotor blade angle control and a torque control, wherein in a full-load operation, starting from a predetermined speed (n_{Absenkung}), a preset torque is lowered by the torque control in such a way that a predetermined value for a provided power (P) is not exceeded.

### CROSS-REFERENCE TO RELATED APPLICATIONS

Not applicable.

### STATEMENT REGARDING FEDERALLY SPONSORED RESEARCH

Not applicable

### BACKGROUND OF THE INVENTION

The invention relates to a method for the operation of a wind turbine generator system with a rotor blade angle control and a torque control.

Siegfried Heyer, in Windkraftanlagen, Systemauslegung, Netzintegration und Regelung, Teubner Verlag, 4th edition, page 321, the entire contents of which are incorporated herein by reference, describes how to restrict the speed of the turbine, while in a full-load operation, to a nominal value by varying a blade setting angle. Likewise, a regulation is effected for the generator torque which regulates the system power into optimum values and leads the system to safe and component-relieving operating conditions.

The power (P) to be outputted by the wind turbine generator system is proportional to the torque (M) and speed (Ω). The interconnection is:

P=M·Ω.

In a full-load operation, the power will rise during strong wind and gusts. This phenomenon, which is referred to as “excess production” is quite acceptable for free-standing systems, but cannot be tolerated in an interaction between multiple wind turbine generator systems, e.g. in a wind farm because there is a risk of the electric mains getting overloaded.

It is the object of the invention to perform the operation of the wind turbine generator system, while in a full-load operation, such as to restrict the power to be outputted to a maximum value by simple means.

### BRIEF SUMMARY OF THE INVENTION

In the inventive method, in a full-load operation, a preset torque is lowered starting from a predetermined speed (n_{Absenkung}). Lowering is done in such a way that a predetermined value for a provided power is not exceeded. In a full-load operation, it is common to adjust the speed of the turbine via the blade setting angle. This allows for a certain control within the full-load range already. However, the preset torque is reduced from a predetermined speed onwards to prevent the transgression of the maximum power value to be outputted even if the speed increases. In case that the preset torque is reduced according to the above indicated interconnection between the torque and power a reduced power will arise when the speed increases. This makes it possible to limit the power even if the speed rises.

To achieve a high power yield it has proved to be particularly beneficial in the inventive method not to choose the rated speed as a predetermined speed for lowering the preset torque but a value instead which is slightly larger than the rated speed. Because of this value for the predetermined speed from which onwards the reduction of the preset torque is performed such full-load operation is distinguished into two sections: there is exclusively a regulation of the angle of blade attack in the first of these sections whereas both a torque control and control of the angle of blade attack takes place in the second section.

For the predetermined speed from which onwards there is a reduction of the preset value, it is preferable to choose a value which is larger by 0.5% to 5% than is the rated speed.

However, the rotor blade angle control will expediently regulate the attack of the blade angle already while starting from the rated speed. Thus, the result is that a regulation for speeds between the rated speed and the predetermined speed is done by the angle of blade attack only and, from the predetermined speed onwards, is done by both the control for the angle of blade attack and the preset torque.

In the inventive method, a first preset torque, which matches with the torque for the continuous-operation power, is determined for the maximum value of the power provided. Preferably, a second preset torque, which matches with the actual torque, is also determined for the maximum value of the power provided, wherein the smaller value of the first and second preset torques is applied to the torque control. The interconnection between the preset torque and the speed preferably is inversely proportional here, i.e. the preset torque is proportional to the reciprocal value of the speed. Based on the speed values present during the operation control of the wind turbine generator system, the hyperbolic course of the torque over the speed is largely approximated through a straight line.

In the inventive method, the torque control predetermines the reduction of the preset torque. At the same time, the control for the rotor blade angle controls the speed into the predetermined speed value. The value for the preset torque that is determined by the torque control corresponds to a predetermined maximum value of power.

### BRIEF DESCRIPTION OF THE SEVERAL VIEWS OF THE DRAWINGS

The inventive method will be described in more detail below with reference to two figures. In the drawings:

FIG. 1 shows the course of power over the speed, and

FIG. 2 shows the course of the preset moment over the speed.

FIG. 3 shows a block diagram of the inventive wind turbine generator system.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

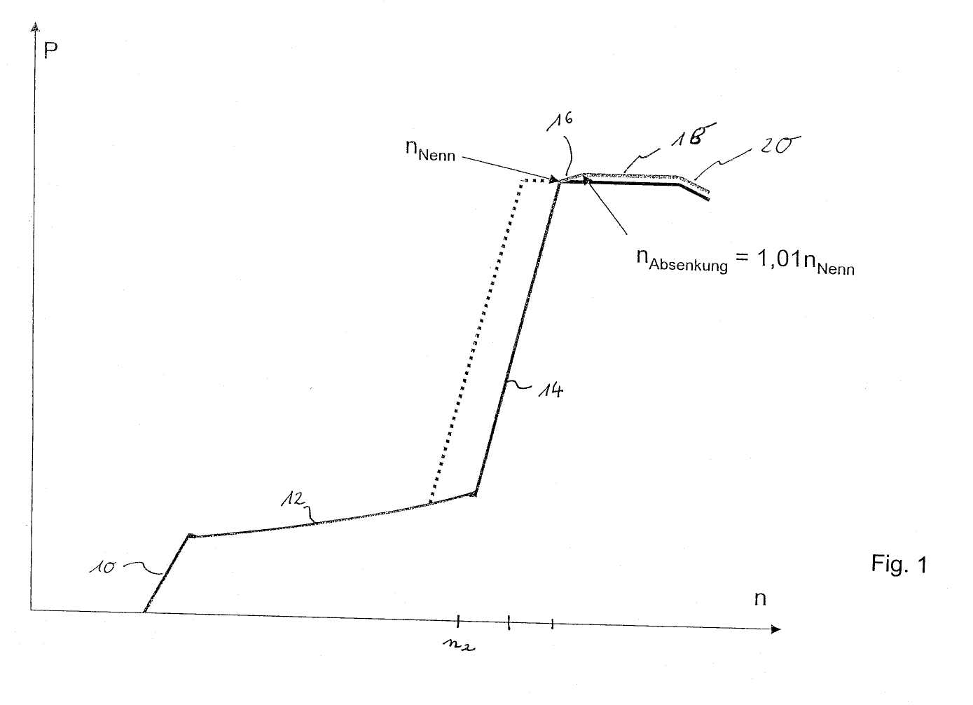

For a general explanation, the characteristic-curve field shown in FIG. 1 for the regular behaviour of the wind turbine generator system will be explained first. The characteristic-curve field has a first section 10 in which the effective power P rises linearly with the speed. It is followed by a second section 12 in which the power does not depend linearly on the speed. Different curve runs are possible here. In the second section 12 of the characteristic curve, it is preferred to regulate power in conformity with the power P_{Aero} as inputted from the wind. The mathematical interconnection between the speed and power ensues from the following formula:

$${P}_{Aero} = {[ 2 \cdot π \cdot {r}_{rot} \cdot \frac{{n}_{gen}}{{\ddot{u}}_{getr}} \cdot \frac{1}{60} \cdot \frac{1}{λ ( {n}_{ro} t )} ]}^{3} \cdot π \cdot {r}_{rot}^{2} \cdot \frac{ρ luft}{2} \cdot {c}_{p} ( {n}_{ro} t )$$

where rᵣₒₜ is for the radius of the rotor blade, n_{gen} is for the generator speed, ü_{getr} is for the speed ratio of the transmission. λ(nᵣₒₜ) signifies the high-speed number of the rotor dependent on the speed of the rotor, ρ_{luft} denotes the density of the air while cp(nᵣₒₜ) describes a power value coefficient for the rotor blade dependent on the speed of the rotor.

Starting from a speed n₂, the wind turbine generator system is led to the full-load range from the partial-load range. To this end, the speed is increased to the rated speed. At this time, the increase in power is made in a linear proportion to the speed along section 14.

When the rated speed is reached another characteristic-curve section 16 will follow in full-load operation up to a reduction in speed. Power will increase in a linear proportion to the speed in the characteristic-curve section 16. In the characteristic-curve section 18 which follows, power over the speed remains constant. In the characteristic-curve section 20 which then follows, power will decrease again in order to finally be cancelled completely from a certain speed onwards.

The speed from which onwards power is constant independently of an increase in speed is 1.01 times the rated speed in the example shown; hence, it is by 1% higher than the rated speed. Because of this speed which is increased over the rated speed, the power provided is by 1% higher than the power which results for the rated speed.

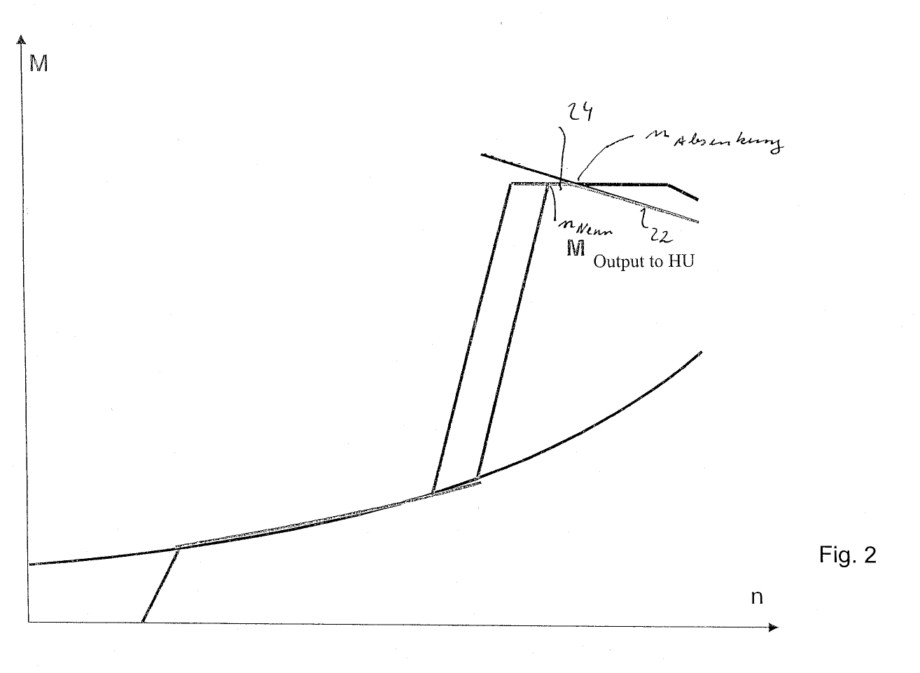

The initially discussed interconnection between the power, torque, and speed makes it evident that if the speed increases it is necessary to lower the torque to achieve a constant power. This procedure is illustrated in FIG. 2. FIG. 2 shows the torque curve of the torque presetting made for the main converter. The main converter predetermines the generator torque, e.g. in double fed asynchronous generators.

In a stationary case, the generator torque matches the moment as inputted by the rotor. FIG. 2 also allows to clearly appreciate how the moment initially is kept constant in a full-load operation at a maximum torque over the rated speed and will drop into a section 22 after a speed n_{Absenkung}. Hence, the preset torque as plotted over the speed, in a full-load operation, has a section of a constant torque presetting 24 and a section with a decreasing torque presetting 22. The transition between the two curves takes place at a speed n_{Absenkung}.

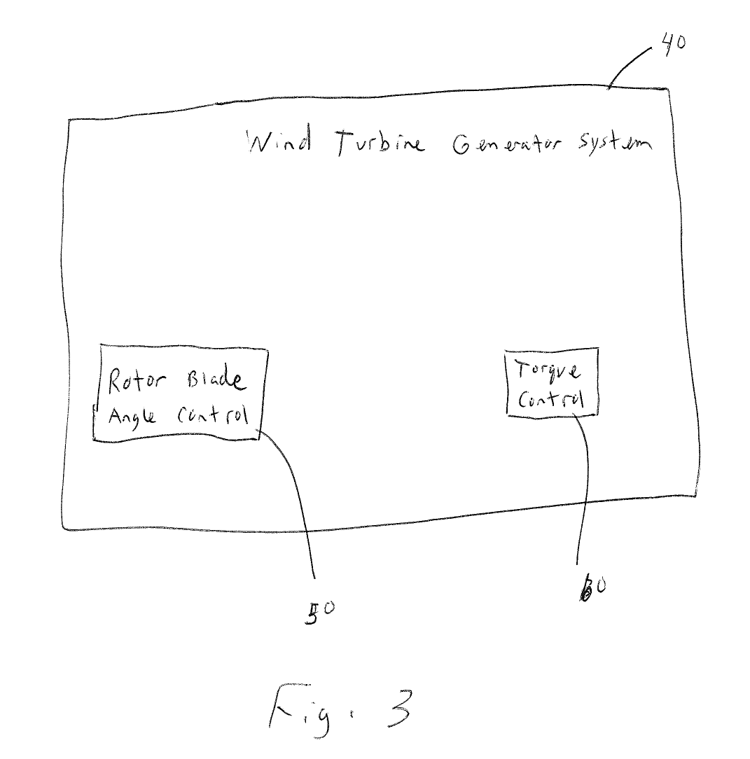

FIG. 3 shows a block diagram of the wind turbine generator system 40 including the rotor blade angle control 50 and the torque control 60.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for the operation of a wind turbine generator system with a rotor blade angle control and a torque control, wherein in a full-load operation, starting from a predetermined speed (n_{Absenkung}), a preset torque is lowered by the torque control in such a way that a predetermined value for a provided power (P) is not exceeded.

2. The method according to claim 1, characterized in that the predetermined speed (n_{Absenkung}) for lowering the torque is larger than the rated speed.

3. The method according to claim 2, characterized in that the predetermined speed (n_{Absenkung}) is larger by 0.5% to 5% than is the rated speed (nₙₑₙₙ).

4. The method according to claim 1, characterized in that the rotor blade angle control, when in a full-load operation, controls the rotor blade angle while starting from the rated speed.

5. The method according to claim 1, characterized in that a first preset torque, which matches with the torque for the continuous-operation power, is determined for the maximum value of the power provided.

6. The method according to claim 5, characterized in that a second preset torque, which matches with the actual torque, is determined for the maximum value of the power provided, wherein the smaller value of the first and second preset torques is applied to the torque control,

7. The method according to claim 1, characterized in that the rotor blade angle control regulates the speed to the determined speed and the torque control regulates the preset torques into a value which matches a predetermined maximum value of powers.
